(19) United States
(12) Patent Application Publication
(10) Pub. No.: US 2006/0160937 A1
(43) Pub. Date: Jul. 20, 2006

(54) Solid composition containing at least one low-melting surfactant

(75) Inventors: Jean-Pierre Hecaen, Stains (FR); Laurent Taisne, Paris (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Rhodia Chimie, Courbevoie (FR)

(21) Appl. No.: 11/312,518

(22) Filed: Dec. 21, 2005

Related U.S. Application Data
(62) Division of application No. 09/959,481, filed on Feb. 7, 2002.

(30) Foreign Application Priority Data
Apr. 26, 1999 (FR) 99/05247

(51) Int. Cl. C08K 5/06

(52) U.S. Cl. 524/391

(57) ABSTRACT

A solid composition containing at least one surfactant with a low melting point and at least one polymer obtained from the following: (i) an unsaturated sulphonic or carboxylic acid and/or unsaturated carboxylic polyoxyalkylenated ester and an optionally unsaturated monomer, optionally comprising the functions of an ester, an amide or an aromatic nucleus; (ii) an unsaturated sulphonic or carboxylic acid, whereby the polymer comprises hydrophobic grafts; (iii) a monomer which is unsaturated and includes hydroxyl groups or hydroxyl precursors, whereby the polymer includes hydrophobic grafts; (iv) polypeptides comprising hydrophobic grafts; (v) polysaccharides which are highly depolymerized and comprise hydrophobic grafts. A method for the production of the composition involves drying an aqueous solution containing the surfactant and the polymer. The composition is useful as a constitutive element of phytosanitary formulations.

### CROSS REFERENCE TO RELATED APPLICATIONS

This application is a divisional of U.S. Ser. No. 09/959,481, filed Feb. 7, 2002, which claims priority under 35 U.S.C. § 371 of PCT Application No. FR00/01111, filed Apr. 26, 2000 and claims priority of FR99/05247, filed Apr. 26, 1999.

### BACKGROUND OF THE INVENTION

1. Field of the Invention

The present invention relates to a composition in a solid form, comprising at least one low-melting surfactant, to a process for preparing it and to its use.

2. Description of Related Art

It is advantageous in many fields to have available surfactants which are in solid form, so as to be able, for example, to incorporate them into solid formulations. The reason for this is that such a shaping operation makes the surfactant easier to use. However, many surfactants do not lend themselves to this type of use due to the fact that they are in a liquid form at a relatively low temperature.

One possibility for overcoming the incompatibility of liquid surfactants and solid formulations consists in absorbing said surfactant on a support, for example such as silica. However, silica cannot always be used in all fields, such as, for example, that of agrochemical formulations. The reason for this is that silica is insoluble in aqueous solutions and has a tendency to flocculate, which may result in blockage of the apparatus used to apply the formulation comprising the surfactant.

### SUMMARY OF THE INVENTION

One of the aims of the invention is to propose an operation for placing low-melting surfactants in solid form, which does not present the above problems.

One subject of the present invention is thus a composition in a solid form, comprising:

at least one low-melting surfactant,

at least one polymer chosen from:
(i) polymers or copolymers obtained by polymerization
   of at least one monomer (I) bearing one or more functions chosen from the following: carboxylic acid in acid or salified form, or carboxylic acid precursor, or sulfonic acid, in acid or salified form, and/or
   of at least one polyoxyalkylenated ethylenically unsaturated carboxylic acid ester monomer (II), and optionally
   of at least one monoethylenically or polyethylenically unsaturated, nonionic, linear or branched C₃-C₁₂ monomer (III);
(ii) polymers obtained by polymerization of at least one monomer (I) bearing one or more functions chosen from the following: carboxylic acid in acid or salified form, or carboxylic acid precursor, or sulfonic acid, in acid or salified form, the polymer also comprising at least one saturated or unsaturated, aromatic or nonaromatic C₄-C₃₀ hydrocarbon-based hydrophobic graft, optionally interrupted with one or more hetero atoms;
(iii) polymers obtained by polymerization of at least one monoethylenically or polyethylenically unsaturated linear or branched monomer (V) bearing one or more hydroxyl groups or hydroxyl group precursors, this polymer also comprising at least one saturated or unsaturated, aromatic or nonaromatic C₄-C₃₀ hydrocarbon-based hydrophobic graft, optionally interrupted with one or more hetero atoms;
(iv) polypeptides of natural or synthetic origin comprising at least one saturated or unsaturated, aromatic or nonaromatic C₄-C₃₀ hydrocarbon-based hydrophobic graft, optionally interrupted with one or more hetero atoms;
(v) highly depolymerized polysaccharides comprising at least one saturated or unsaturated, aromatic or nonaromatic C₄-C₃₀ hydrocarbon-based hydrophobic graft, optionally interrupted with one or more hetero atoms.

A subject of the present invention is also a process for preparing the composition, which consists in carrying out the following steps:

preparing an aqueous solution comprising at least one low-melting surfactant and at least one polymer,

drying the solution thus obtained.

Lastly, a final subject of the invention relates to the use of said composition as constituent element of plant-protection formulations, which are more particularly solid.

The present invention proposes a solution to the problems of shaping liquid products or low-melting products, which are usually formulated by absorption onto a support.

The invention also has the advantage of having its shaping adapted according to the needs. Thus, it may be in the form of a powder, but it is equally possible, advantageously, to envisage granulating or flaking the composition according to the invention or alternatively the formulation containing it, without encountering any difficulties.

The composition according to the invention has the advantage firstly of redissolving and secondly of conserving all the properties of the surfactant (for instance the surface tension), as if the surfactant was alone in the solution. In other words, the polymer with which the surfactant is combined in the composition according to the invention has no effect on the properties of the surfactant, once the composition is redissolved. It should be noted that such a result was, in principle, not obvious, since a reduction in the properties would have been expected due to some of the surfactant remaining combined with the polymer, as occurs when a compound is combined with a support.

### BRIEF DESCRIPTION OF THE DRAWING

The attached FIGURE represents curves of surface tensions of a composition according to the invention once redissolved, as a function of the concentration of the solution, compared with that of a solution comprising only the surfactant.

### DETAILED DESCRIPTION OF PREFERRED EMBODIMENTS

It has also been found, entirely surprisingly, that the use of the composition according to the invention makes it possible to obtain formulations in the form of extruded granules, whereas the use of the surfactant alone does not allow a satisfactory result to be achieved.

Finally, the composition according to the invention may have a role as a biological activator for the plant-protection active material forming part of the composition of the plant-protection formulation.

However, other advantages and characteristics will emerge more clearly on reading the description and the examples which follow.

As has been mentioned previously, the composition according to the invention comprises at least one low-melting surfactant.

It is pointed out that, for the purposes of the present invention, the expression “low-melting surfactant” denotes surfactants with a melting point of less than 80° C. More particularly, said surfactants have a melting point of less than 50° C. Preferably, the surfactants are liquid at room temperature.

Among the surfactants that are suitable, mention may be made in particular of the following surfactants:

polyoxyalkylenated fatty alcohols

polyoxyalkylenated triglycerides

polyoxyalkylenated fatty acid esters

polyoxyalkylenated sorbitan esters

polyoxyalkylenated fatty acid amides

polyoxyalkylenated fatty amines

polyoxyalkylenated amido amines

polyoxyalkylenated bis(1-phenylethyl)phenols

polyoxyalkylenated tris(1-phenylethyl)phenols

polyoxyalkylenated alkylphenols

products resulting from the condensation of ethylene oxide or of propylene oxide with ethylenediamine

alkoxylated terpenic hydrocarbons such as polyoxyalkylenated α- or β-pinene derivatives

alkylpolyglycosides which may be obtained by condensation of glucose with primary fatty alcohols containing a C₄-C₂₀ alkyl group and also an average number of glucose units of about 0.5 to 3 per mole of alkylpolyglycoside.

The term “oxyalkylenated” denotes oxyethylenated, oxypropylenated or oxybutylenated units, or combinations thereof. Preferably, the surfactants used comprise oxyethylenated or oxyethylenated and oxypropylenated units.

The number of oxyethylenated (OE) and/or oxypropylenated (OP) units in these nonionic surfactants usually ranges from 1 to 50 depending on the melting point of the surfactant. More particularly, the number of OE or OE/OP units is between 1 and 40.

The ethoxylated or ethoxy-propoxylated fatty alcohols generally contain from 6 to 22 carbon atoms, the OE and OP units being excluded from these numbers. Preferably, these units are ethoxylated units.

The ethoxylated or ethoxy-propoxylated triglycerides may be triglycerides of plant or animal origin (such as lard, tallow, groundnut oil, butter oil, cottonseed oil, flax oil, olive oil, fish oil, palm oil, grapeseed oil, soybean oil, castor oil, rapeseed oil, palm kernel oil or coconut oil) and are preferably ethoxylated.

The ethoxylated or ethoxy-propoxylated fatty acid esters generally contain, for the acid part, from 6 to 22 carbon atoms, the OE and OP units being excluded from these numbers, and are preferably ethoxylated.

The ethoxylated or ethoxy-propoxylated sorbitan esters are cyclized sorbitol esters of fatty acid containing from 10 to 20 carbon atoms, for instance lauric acid, stearic acid or oleic acid, and are preferably ethoxylated.

In the present invention, the term “ethoxylated triglyceride” means both products obtained by ethoxylation of a triglyceride with ethylene oxide and/or with propylene oxide, and those obtained by transesterification of a triglyceride with a polyethylene glycol and/or polypropylene glycol.

Similarly, the term “ethoxylated fatty acid ester” includes both the products obtained by ethoxylation of a fatty acid with ethylene oxide and those obtained by transesterification of a fatty acid with a polyethylene glycol.

The ethoxylated or ethoxy-propoxylated fatty amines and amides generally contain from 6 to 22 carbon atoms, the OE and OP units being excluded from these numbers, and are preferably ethoxylated.

The ethoxylated or ethoxy-propoxylated amido amines generally contain from 2 to 22 carbon atoms for the hydrocarbon-based units, the OE and OP units being excluded from these numbers, and are preferably ethoxylated.

It should be noted that, depending on the pH at which the surfactants comprising amine functions are used, these functions may be in a nonionic or cationic form.

The ethoxylated or ethoxy-propoxylated alkylphenols are generally 1 or 2 linear or branched alkyl groups containing 4 to 12 carbon atoms. By way of example, mention may be made especially of octyl, nonyl and dodecyl groups.

As examples of surfactants of the ethoxy or ethoxy-propoxylated alkylphenol group, mention may be made of nonylphenol ethoxylated with 2 OE units, nonylphenol ethoxylated with 4 OE units, nonylphenol ethoxylated with 6 OE units and nonylphenol ethoxylated with 9 OE units.

As examples of surfactants of the ethoxy or ethoxy-propoxylated bis- and tris(1-phenylethyl)phenol group, mention may be made especially of bis(1-phenylethyl)phenol ethoxylated with 5 OE units, bis(1-phenylethyl)phenol ethoxylated with 10 OE units, tris(1-phenylethyl)phenol ethoxylated with 16 OE units, tris(1-phenylethyl)phenol ethoxylated with 20 OE units, tris(1-phenylethyl)phenol ethoxylated with 25 OE units, tris(1-phenylethyl)phenol ethoxylated with 40 OE units and tris(1-phenylethyl)phenols ethoxy-propoxylated with 25 OE+OP units.

It is likewise possible to use, as constituent of the composition according to the invention, an ionic surfactant chosen from:

sulfated or phosphated polyoxyalkylenated fatty alcohols

sulfated or phosphated polyoxyalkylenated bis(1-phenylethyl)phenols

sulfated or phosphated polyoxyalkylenated tris(1-phenylethyl)phenols

sulfated or phosphated polyoxyalkylenated alkylphenols.

The sulfate function is as follows: —SO₃M in which M represents a hydrogen atom, an alkali metal such as sodium or potassium, for example, an ammonium radical N(R₄)⁺ with R, which may be identical or different, representing a hydrogen atom or a hydrocarbon-based radical containing 1 to 4 carbon atoms, optionally bearing a hydroxyl radical.

The phosphate function may be represented by the following formulae: >P(═O)[OM] or —P(═O)(OM]₂, in which M has the same meaning as above.

The composition according to the invention also comprises at least one polymer or copolymer chosen from a list of five types of (co)polymer. In the text hereinbelow and for the purpose of simplifying the description, only the term polymer will be used, given that it will denote both homopolymers and copolymers.

Furthermore, the polymer according to the invention may correspond to one type of polymer or alternatively to a combination of several of them.

It has been found that the polymers, which will be described below, have an associative nature with the surfactant, thus avoiding any appreciable separation of the two compounds in a concentrated solution.

As has been mentioned previously, a first variant of the invention consists in using at least one polymer derived from the polymerization:

of at least one monomer (I) bearing one or more functions chosen from the following: carboxylic acid in acid or salified form, or carboxylic acid precursor, or sulfonic acid, in acid or salified form, and/or

of at least one monomer (II) which is a polyoxyalkylenated ester of an ethylenically unsaturated carboxylic acid, and optionally

of at least one linear or branched, monoethylenically or polyethylenically unsaturated monomer (III).

More particularly, the monomer (I) is chosen from those which make it possible to obtain, after polymerization, hydrophilic unitary units.

In addition, the expression “function which is a precursor of a carboxylic acid function” means anhydrides, for example.

Preferably, the monomer (I) comprises one or more carboxylic acid functions, in acid or salified form.

According to one particular embodiment of the invention, the monomer (I) corresponds to the following formula:
(R¹)(R¹)—C═C(R¹)—COOH (I)
in which formula the radicals R¹, which may be identical or different, represent a hydrogen atom, a C₁-C₁₀ hydrocarbon-based radical optionally comprising a —COOH group, or a —COOH group.

It should be noted that the monomer (I) may be in the form of an anhydride if it comprises several carboxylic functions.

As regards the monomer (II), this corresponds more particularly to the following formula:
CH₂═C(R²⁰)—C(O)—O—[CH(R²¹)CH(R²²)O]ₘ—[CH₂—CH₂O]ₙ—R²³ (II)
in which formula:
R²⁰ is a hydrogen atom or a methyl radical,
R²¹ and R²² represent a hydrogen atom or an alkyl radical containing from 1 to 4 carbon atoms, on condition that they are not both simultaneously an alkyl radical or a hydrogen atom; preferably, R²¹ represents a hydrogen and R²² represents an alkyl radical,
R²³ is an alkyl, aryl, alkylaryl or arylalkyl radical containing from 1 to 30 and preferably from 6 to 30 carbon atoms, n is between 2 and 100 and preferably between 6 and 100 and m is between 0 and 50, with the proviso that n is greater than or equal to m and their sum is between 2 and 100 and preferably between 6 and 100; the position of the blocks —CH(R²¹)CH(R²²)O— and —CH₂—CH₂O possibly being inverted.

Preferably, the position of said blocks is as given in formula (II) above.

As regards the monomer of formula (III), it is more particularly a nonionic C₃-C₁₂ α,β-ethylenically unsaturated monomer.

It preferably corresponds to the following formula:
(R³¹)(R³²)C═CH₂ (III)

in which formula:

the radicals R³¹ and R³², which may be identical or different, represent a linear or branched C₁-C₁₀ hydrocarbon-based radical or a hydrogen atom, on condition that R³¹ and R³² do not simultaneously represent a hydrogen atom; furthermore:

if R³¹ is a hydrogen atom, then R³² represents a group —COOR^{a}, —OCOR^{a}, —C₆H₄R^{b}, —CONHR^{a} or —CON(R^{a})₂,

if R³¹ is a methyl radical, then R³² represents a group —COOR^{a}, —C₆H₄R^{b}, CONHR^{a} or CON(R^{a})₂,

in which formulae R^{a}, which may be identical or different, represent a C₁-C₁₀ alkyl group or a C₁-C₁₀ hydroxyalkyl group, R^{b} represents a hydrogen, chlorine or bromine atom or a C₁-C₄ alkyl group.

The polymers corresponding to this variant (i) may therefore comprise either a monomer (I) and/or a monomer (II), each of these two monomers possibly being combined with a monomer (III). The polymers corresponding to this variant may similarly contain a combination of each of the three abovementioned monomers.

According to a first embodiment of this variant, a polymer or copolymer comprising monomers of type (I) is used.

According to a second particular embodiment of this first variant, polymers derived from the polymerization of at least one monomer of formula (I) and of at least one monomer of formula (II) may first be mentioned.

Preferably, the monomer of formula (I) used in the first and second mentioned embodiments is a monocarboxylic or polycarboxylic acid corresponding to the following formula:
(R¹¹)HC═C(R¹²)COOH
in which formula:
R¹¹ represents a hydrogen atom, a —COOH group or a group —(CH₂)ₙ—COOH in which n is between 1 and 4, or a C₁-C₄ alkyl radical;
R¹² represents a hydrogen atom, a group (CH₂)ₘ—COOH in which m is between 1 and 4, or a C₁-C₄ alkyl radical.

Preferably, R¹¹ represents a hydrogen atom, a —COOH group or —(CH₂)—COOH group or a methyl radical and R¹² represents a hydrogen atom, a —CH₂—COOH group or a methyl radical.

It should be noted that, if the acid comprises several carboxylic acid functions, it may be in the form of an anhydride.

According to one more particular embodiment, the monomer of formula (I) is chosen from acrylic, methacrylic, citraconic maleic, fumaric, itaconic and crotonic acids and anhydrides.

As regards the monomers of formula (II), the ones preferably used are monomers for which R²¹ is a hydrogen, R²³ is an alkyl radical containing from 8 to 30 carbon atoms, a phenyl radical substituted with one to three 1-phenylethyl groups, an alkylphenyl radical in which the alkyl radical contains from 8 to 16 carbon atoms. According to another embodiment, the monomers of formula (II) are as just described in their preferred form, m furthermore being equal to 0.

Among the monomers of this type which may be used, mention may be made of those described in patents EP 705 854, U.S. Pat. No. 4,138,381 and U.S. Pat. No. 4,384,096.

The polymer obtained by reacting the monomers (I) and/or (II) is preferably obtained by free-radical polymerization.

A second specific embodiment of this first variant consists in using a polymer (i) obtained by polymerization
of at least one monomer of formula (I):
   (R¹)(R¹)C═C(R¹)—COOH
in which formula the radicals R¹, which may be identical or different, represent a hydrogen atom, a C₁-C₁₀ hydrocarbon-based radical optionally comprising a —COOH group, or
a —COOH group; and
of at least one monomer of formula (III):
   (R³¹)(R³²)C═CH₂
in which formula:
   the radicals R³¹ and R³², which may be identical or different, represent a linear or branched C₁-C₁₀ hydrocarbon-based radical or a hydrogen atom, on condition that R³¹ and R³² do not simultaneously represent a hydrogen atom; furthermore:
if R³¹ is a hydrogen atom, then R³² represents a group —COOR^{a}, —OCOR^{a}, —C₆H₄R^{b}, —CONHR^{a} or —CON(R^{a})₂,
if R³¹ is a methyl radical, then R³² represents a group —COOR^{a}, —C₆H₄R^{b}, —CONHR^{a} or —CON(R^{a})₂,
   in which formulae R^{a}, which may be identical or different, represent a C₁-C₁₀ alkyl group or a C₁-C₁₀ hydroxyalkyl group, and R^{b} represents a hydrogen, chlorine or bromine atom or a C₁-C₄ alkyl group.

That which has been described previously regarding the more preferred definitions of the monomers (I) will not be repeated here. Reference may thus be made thereto.

As regards the monomer of formula (III), it may be chosen especially from C₁-C₁₀ hydroxyalkyl or C₁-C₁₀ alkyl esters of acrylic and methacrylic acids. Examples of such monomers which may be mentioned include ethyl acrylate, ethyl methacrylate, 2-ethylhexyl acrylate, butyl acrylate, butyl methacrylate, 2-hydroxyethyl acrylate and 2-hydroxybutyl methacrylate.

Unsaturated esters such as vinyl acetate, vinyl butyrate and vinyl caproate may similarly be used.

The monomer (III) may similarly be chosen from monomers comprising an aromatic nucleus. For example, styrene, vinyltoluene, tert-butylstyrene, hydroxystyrene, isopropylstyrene and p-chlorostyrene are suitable for carrying out the invention.

The monomer may similarly comprise an amide function. For example, N-substituted or N,N′-disubstituted (meth)acrylamides may be suitable for performing the invention.

The monomer (III) may also be chosen from unsaturated hydrocarbon-based monomers such as, especially, propylene, 1-butene, isobutylene, n−1-pentene, 2-methyl-1-butene, n-1-hexene, 2-methyl-1-pentene, 4-methyl-1-pentene, 2-ethyl-1-butene, diisobutylene (or 2,4,4-trimethyl-1-pentene) and 2-methyl-3,3-dimethyl-1-pentene.

According to one particularly advantageous embodiment of the invention, the copolymer of formula (i) is derived from the polymerization of maleic anhydride and of 2,4,4-trimethyl-1-pentene.

It is pointed out that the polymer (i) is obtained more particularly by carrying out a free-radical polymerization of the monomers (I) and (III).

These preferred compounds are well known to those skilled in the art. Copolymers of this type which may be mentioned include the product sold under the name Geropon® T36 (maleic anhydride/diisobutylene) sold by Rhodia Chimie, and Sokalan® CP9 (maleic anhydride/olefin) sold by BASF.

It should be noted that it would not constitute a departure from the scope of the present invention to use a polymer (i) comprising the three types of monomer which have just been described.

The weight-average molecular mass of the polymers (i) is more particularly such that the viscosity of the aqueous solution of polymer and of low-melting surfactant intended to be dried is less than or equal to 10 000 mPa·s and preferably less than or equal to 5 000 mPa·s (RVT Brookfield, 20 rpm, needle No. 5).

As a guide, the weight-average molecular mass of the polymers (i) comprising only units (I) is less than 200 000 g/mol (measured by steric exclusion chromatography).

As a further guide, the weight-average molecular mass of the other polymers (i) is less than 30 000 g/mol and preferably less than 20 000 g/mol (measured by steric exclusion chromatography).

It is also pointed out that the molecular mass of the polymer and the respective proportions of the monomers (I) and (II) and/or (III) are such that the aqueous solution comprising said polymer and the surfactant remains stable at least for the preparation time of the composition according to the invention (drying); the polymer concentration being between 0 exclusive and 90% by weight and preferably between 20% and 80% by weight.

A second variant of the present invention consists in using at least one polymer (ii) derived from the polymerization of at least one monomer of formula (I) as defined above and also comprising at least one saturated or nonsaturated, aromatic or nonaromatic C₄-C₃₀ hydrocarbon-based hydrophobic graft optionally interrupted with one or more hetero atoms.

Everything which has been mentioned previously regarding the monomer of formula (I) is applicable in the case of the polymer (ii) and will therefore not be repeated hereinbelow.

It should be noted that this polymer is preferably obtained by carrying out a free-radical polymerization.

However, more particularly, the monomer (I) is chosen from acrylic, methacrylic, citraconic, maleic, fumaric, itaconic and crotonic acids or anhydrides.

Moreover, the hydrophobic graft is chosen from aliphatic, cyclic, aromatic, alkylaromatic and arylaliphatic radicals containing 3 to 30 carbon atoms and preferably 3 to 22 carbon atoms, and possibly being interrupted with one or more hetero atoms, preferably oxygen. In addition, the graft comprises a function capable of reacting with the free acid functions of the polymer. Thus, the graft is linked to the polymer backbone via ester and/or amide groups especially.

Such grafted polymers are obtained by carrying out methods known to those skilled in the art consisting, in a first stage, in polymerizing, preferably via a free-radical route, the monomer(s) (I), and then in reacting some of the free carboxylic acid functions with reagents chosen especially from propyl, hexyl, heptyl, lauryl and behenyl alcohols or amines, optionally ethoxylated and/or propoxylated, and mono-, di- or tristyrylphenols, optionally ethoxylated and/or propoxylated.

The weight-average molecular mass of the polymers (ii) is more particularly such that the viscosity of the aqueous solution of polymer and of low-melting surfactant intended to be dried is less than or equal to 10 000 mPa·s and preferably less than or equal to 5 000 mPa·s (RVT Brookfield, 20 rpm, needle No. 5). As a guide, the weight-average molecular mass of the polymers (II) is more particularly less than 30 000 g/mol and preferably less than 20 000 g/mol (measured by steric exclusion chromatography).

However, the molecular mass and the respective proportions of monomer(s) (I) and of hydrophobic grafts are such that the aqueous solution comprising said monomer and the surfactant remains stable at least for the preparation time of the composition according to the invention (drying); the polymer concentration being between 0 exclusive and 90% by weight and preferably between 20% and 80% by weight.

The polymers (ii) may also comprise units corresponding to the monomers of formula (III) described above.

A third variant of the present invention consists in using a polymer derived from the polymerization of at least one linear or branched, monoethylenically or polyethylenically unsaturated monomer (V) bearing one or more hydroxyl groups or precursors of hydroxyl groups, the polymer bearing at least one saturated or unsaturated, aromatic or nonaromatic C₄-C₃₀ hydrocarbon-based hydrophobic graft, and possibly being interrupted with one or more hetero atoms, preferably oxygen.

The monomer (V) corresponds more particularly to the following formula:
(R⁵)(R⁵)C═CH₂
in which formula the radicals R⁵, which may be identical or different, represent a linear or branched C₁-C₁₀ radical, at least one of them being a hydroxyl group or a precursor of a hydroxyl group.

Preferably, at least one of the radicals R⁵ bears a precursor group of a hydroxyl group.

Among the precursor groups of hydroxyl groups which should be noted most particularly are ester functions for which the alcohol is attached to the monomer. Thus, vinyl monomers of the vinyl acetate type are suitable for the invention.

This variant is particularly suitable for obtaining polymers of the polyvinyl alcohol type.

That which has been described previously regarding the hydrophobic grafts remains valid and will not be repeated in this part of the text. It should be noted more particularly that the grafts bear functions capable of reacting with the hydroxyl functions of the polymer. As examples, these grafts may be attached to the polymer backbone via ester bonds, for example.

The weight-average molecular mass of the polymers (iii) is more particularly such that the viscosity of the aqueous solution of polymer and of low-melting surfactant intended to be dried is less than or equal to 10 000 mPa·s and preferably less than or equal to 5 000 mPa·s (RVT Brookfield, 20 rpm, needle No. 5). As a guide, the weight-average molecular mass of the polymers (iii) is more particularly less than 30 000 g/mol and preferably 20 000 g/mol (measured by steric exclusion chromatography).

However, the molecular mass and the respective proportions of monomer(s) (I), optionally of monomers (III) and of hydrophobic grafts are such that the aqueous solution, comprising said polymer and the surfactant, remains stable at least for the preparation time of the composition according to the invention (drying); the polymer concentration being between 0 exclusive and 90% by weight and preferably between 20% and 80% by weight.

A fourth variant of the present invention consists in using as polymer at least one polypeptide of natural or synthetic origin, comprising at least one saturated or unsaturated, aromatic or nonaromatic C₄-C₃₀ hydrocarbon-based hydrophobic graft optionally interrupted with one or more hetero atoms.

The peptide polymers of natural or synthetic origin are homopolymers or copolymers derived from the polycondensation of amino acids, especially of aspartic acid and glutamic acid or of diamino diacid precursors, and hydrolysis. These polymers may be either homopolymers derived from aspartic or glutamic acid, or copolymers derived from aspartic or glutamic acid in any proportions, or copolymers derived from aspartic and/or glutamic acid and from other amino acids. Among the copolymerizable amino acids which may be mentioned, inter alia, are glycine, alanine, leucine, isoleucine, phenylalanine, methionine, histidine, proline, lysine, serine, threonine, cysteine, etc.

Among the polypeptides of natural origin which may be mentioned are water-soluble or water-dispersible proteins of plant or animal origin. The proteins of plant origin are preferably protein hydrolyzates. Their degree of hydrolysis is more particularly less than 40%.

Among the proteins of plant origin which may be mentioned, as a guide, are proteins originating from proteaginous seeds, especially those of pea, fava bean, lupin, haricot bean and lentil; proteins originating from cereal seeds, especially those of wheat, barley, rye, corn, rice, oat and millet; proteins originating from oleaginous seeds, especially those of soybean, groundnut, sunflower, rapeseed and coconut; proteins originating from leaves, especially alfalfa and nettle; proteins originating from plant organs and buried reserves, especially those of potato and beetroot.

Among the proteins of animal origin which may be mentioned, for example, are muscle proteins, especially stromal proteins, and gelatin; proteins originating from milk, especially casein and lactoglobulin; and fish proteins.

The proteins of plant origin, and more particularly the proteins obtained from soybean and from wheat, are preferred.

That which has been mentioned previously regarding the nature of the hydrophobic graft remains valid and will not be repeated here.

It should be noted that the hydrophobic grafts may be linked to the polypeptide via amide, ester, urethane or amine bonds.

The grafted polymers are obtained by reacting some of the free amine or acid functions with compounds allowing the abovementioned bonds to be created.

The preferred compounds have a low degree of polymerization. More particularly, by way of illustration, the weight-average molecular mass is less than 30 000 g/mol and preferably less than 20 000 g/mol (measured by steric exclusion chromatography).

It should be pointed out that the molecular mass of the polymer and the proportion of grafts relative to the polypeptide are such that the aqueous solution comprising said polymer and the surfactant remains stable at least for the preparation time of the composition according to the invention (drying); the polymer concentration being between 0 exclusive and 90% by weight and preferably between 20% and 80% by weight. Furthermore, the viscosity of the aqueous solution of polymer and of low-melting surfactant intended to be dried is more particularly less than or equal to 10 000 mPa·s and preferably less than or equal to 5 000 mPa·s (RVT Brookfield, 20 rpm, needle No. 5).

According to a final variant of the present invention, the polymer is chosen from highly depolymerized polysaccharides comprising a saturated or unsaturated, aromatic or nonaromatic C₄-C₃₀ hydrocarbon-based hydrophobic graft, optionally interrupted with one or more hetero atoms.

Such compounds are described especially in the book by P. Arnaud entitled “cours de chimie organique [Course in organic chemistry]”, published by Gauthier-Villars, 1987.

As nonlimiting examples of highly depolymerized polysaccharides, mention may be made of those obtained from dextran, from starch, from maltodextrin, from xanthan gum and from galactomannans such as guar or carob.

These polysaccharides preferably have a melting point of greater than 100° C. and a water solubility of between 50 and 500 g/l.

As regards the hydrophobic grafts, reference may be made to that which has been mentioned previously.

It should be noted that the hydrophobic grafts may be linked to the polypeptide via ester, amide, urethane or amine bonds.

The grafted polymers are obtained by reacting some of the free acid or alcohol functions with compounds allowing the abovementioned bonds to be created.

More particularly, by way of illustration, the weight-average molecular mass of these polymers is less than 30 000 g/mol and preferably less than 20 000 g/mol (measured by steric exclusion chromatography).

However, it is pointed out that the molecular mass of the depolymerized polymer and the proportion of grafts relative to the polysaccharide are such that the aqueous solution comprising said polymer and the surfactant remains stable at least for the preparation time of the composition according to the invention (drying); the polymer concentration being between 0 exclusive and 90% by weight and preferably between 20% and 80% by weight. Furthermore, the viscosity of the aqueous solution of polymer and of low-melting surfactant intended to be dried is more particularly less than or equal to 10 000 mPa·s and preferably less than or equal to 5 000 mpa·s (RVT Brookfield, 20 rpm, needle No. 5).

Needless to say, it is entirely possible to envision using these various types of water-soluble or water-dispersible compounds in combination.

It is possible to add to the composition according to the invention any conventional filler depending on the field of application for which it is intended.

The amount of filler may vary within a wide range. By way of illustration, the amount ranges between 0 and 50(excluded)% by weight of the composition.

Among the fillers which may be mentioned are soluble mineral salts, for instance alkali metal (sodium or potassium) carbonates and bicarbonates, sugars such as glucose, sucrose, lactose, maltose, dextrose, dextran, maltodextrin, etc. It is similarly possible to incorporate calcium salts or alkaline-earth metal salts, such as calcium chloride or magnesium chloride, for example.

Anticaking agents may also be used, which are preferably incorporated at the time of the drying step, or once this step has been performed.

The weight ratio of the concentrations between the low-melting surfactant and the polymer may also vary within a wide range. However, according to one particularly advantageous embodiment of the invention, the weight ratio of the concentrations is between 50/50 and 90/10.

The process for preparing the composition will now be described.

As mentioned above, the process consists, in a first step, in preparing a solution in aqueous medium, of at least one low-melting surfactant or of at least one polymer.

The preparation is performed by simple mixing of the compounds mentioned above. It may take place in any apparatus equipped with mechanical stirring means.

The mixture is advantageously produced at a temperature at which the surfactant is in a liquid form.

The amount of solids in the mixture before the drying operation is generally between 40% and 70% by weight.

The respective contents of various constituents are chosen such that the dried solids have the composition defined previously.

The second step of the preparation process according to the invention consists in drying the mixture thus obtained to obtain a solid.

The method used to remove the water from the mixture and to obtain the solid may be carried out by any means known to those skilled in the art. Thus, an oven drying may be envisioned. However, according to one particular embodiment of the invention, a method of “flash” drying of said mixture is used.

Spray-drying, or drying using Duprat® drums, and freeze-drying (freezing-sublimation) are suitable in this respect.

It should be noted that methods of drying with fast kinetics (spraying, Duprat® dryer) are advantageous since they give solids in which the distributions of the various constituent elements is very homogeneous.

The spray-drying may be carried out in the usual manner in any known apparatus such as, for example, a spraying tower combining a spraying operation performed using a nozzle or a turbine with a stream of hot gas.

The inlet temperature of the hot gas (generally air), into the top of the column, is preferably between 100 and 115° C., and the outlet temperature is preferably between 55 and 65° C. These temperatures are given as a guide, and depend on the heat stability of the various components.

In the case of mixture-drying operations performed using a Duprat® drum, or any means for rapidly obtaining a dry film which is separated from the drying support by a scraping operation, for example, particles (or flakes) are obtained, which may optionally be ground (to obtain a powder). If necessary, these particles may undergo a further implementation, for instance an agglomeration step, so as to obtain granules.

As has been mentioned previously, the composition according to the invention may be used as a constituent component of plant-protection formulations, and more particularly of solid formulations.

It should be noted that the composition according to the invention is most particularly suitable for obtaining plant-protection formulations in the form of extruded compounds.

The amount of composition contained in the plant-protection formulation is usually between 5% and 40% by weight of the plant-protection formulation, and preferably between 10% and 40% by weight of the plant-protection formulation.

The expression “plant-protection formulation” means any composition intended for uses in agriculture, comprising at least one biologically active material, such as, especially, pesticides, but also nutrient elements which promote the growth and development of the plants. The term “pesticides” denotes, inter alia, herbicides, fungicides, acaricides, insecticides and nematicides.

It should be noted that the composition according to the invention may be used with any type of plant-protection active material. Preferably, solid active materials are used.

As nonlimiting examples of suitable active materials, mention may be made, inter alia, of amethryne, diuron, linuron, chlortoluron, isoproturon, nicosulfuron, metamitron, primsulfuron-methyl, metsulfuron-methyl, aclonifen, atrazine, chlorothalonil, cymoxanil, mancozeb, zineb, phenmedipham, the phenoxy family, the aminophosphate and aminophosphonate family, CMPP, MCPA, 2,4-D, simazine, bromoxynil, active products of the imidazolinone series such as imazapyr, imazaquine, imazethapyr and imazamethabenz.

As regards the nutrient elements, these are preferably salts of metals such as zinc and iron, for example, and preferably of manganese. These salts are used in the form of chelates of EDTA type, for example, or of sulfates.

Among the preferred active materials which will be mentioned most particularly are herbicides chosen from aminophosphate or aminophosphonate derivatives, and preferentially glyphosate, sulfosate or glufosinate, and also the respective organic or mineral salts of these compounds.

Preferably, the formulations according to the invention comprise glyphosate (N-phosphonomethylglycine and its derivatives) and more particularly glyphosate in salt form.

Suitable salts which may be mentioned more particularly are the alkali metal salts, for instance the sodium and potassium salt; the ammonium salts, of N(R)₄⁺ type for which the radicals R, which may be identical or different, represent a hydrogen atom or a linear or branched, saturated or unsaturated C₁-C₆ hydrocarbon-based radical, optionally substituted with a hydroxyl group; or alternatively the sulfonium salts; said salts being present alone or in combination.

Among the ammonium salts which may be mentioned most particularly are primary or secondary amines, for instance isopropylamine and dimethylamine, or diamines, for instance ethylenediamine. As regards the sulfonium salts, trimethylsulfonium is entirely suitable; the isopropylamine salts and the trimethylsulfonium salt being preferred.

The amount of active material in the solid plant-protection formulation usually represents 30% to 95% by weight relative to the total weight of the solid plant-protection composition.

The plant-protection formulation may similarly [lacuna] additives that are conventional in the field.

Thus, it may advantageously comprise compounds whose role is to increase the efficacy of the active material. For example, as regards aminophosphates, and most particularly glyphosate, mention may be made of the ammonium salts, for instance ammonium sulfate, for example. The content of this type of compound may represent up to 40% by weight of the plant-protection formulation.

The formulations may similarly comprise dispersants such as, for example, polymers of the lignosulfonate type (sodium, calcium or ammonium salts) optionally combined with an ethoxylated, optionally sulfated, and neutralized, di- or tristyrylphenol, maleic anhydride/isobutylene copolymers (sodium or ammonium salts), condensed phenylsulfonic acids (sodium salts), or condensed naphthalenesulfonate/formaldehyde polymers (sodium or ammonium salts). The content of dispersant is usually less than or equal to 20% by weight of the formulation.

Possible additives for the plant-protection formulations which may also be mentioned are wetting agents, in a content ranging up to 10% by weight of the formulation. These agents may be chosen, inter alia, from anionic agents such as, for example, alkylnaphthalene sulfonates, alkylbenzene sulfonates, alkyl sulfosuccinates, alkyl taurates and alkyl sulfates. Nonionic wetting agents such as acetylenic diols, ethoxylated alkylphenols, etc. may also be used.

As additive of the disintegrating agent and/or binder type, starch, crosslinked polyvinylpyrrolidones, microcrystalline cellulose, crosslinked sodium carboxymethylcellulose, soybean polysaccharides, ion-exchange resins, ethylene oxide/propylene oxide copolymers and polyethoxylated alkylphenols may especially be suitable. The content of compounds of this type, when they are present, is generally not more than 10% by weight of the formulation.

Anticaking agents may also be used, for instance ammonium or sodium phosphate, sodium carbonate or bicarbonate, sodium acetate, sodium metasilicate, magnesium, zinc or calcium sulfate, magnesium hydroxide, calcium chloride, molecular sieves, sodium alkylsulfosuccinates, and barium or calcium oxide. The content of these additives usually remains less than 10% by weight of the formulation.

Stabilizers may be included in the composition of the plant-protection formulations, in a proportion of not more than 10% by weight of the formulation, such as, for example, alkaline-earth metal or transition metal sulfates, sodium hexametaphosphate, calcium chloride or boric oxide.

Inert fillers, for instance clays, synthetic silicas and diatomaceous earths, calcium or magnesium silicate, titanium dioxide, aluminum, zinc or calcium oxide, calcium or magnesium carbonate, sodium, ammonium or calcium sulfate, and carbon black may also be added to the formulations. The fillers may represent up to 50% by weight of the formulation.

However, other compounds may similarly be included in the composition of the plant-protection formulations, for instance additional surfactants, antifoams, etc.

The plant-protection formulations may be obtained by mixing together these various constituents. This mixing may be performed dry, optionally by grinding the mixture, if the nature of the compounds allows it. It is usually followed by an aggregation step by adding an aqueous medium, preferably water, to the particles obtained. Once the aggregation has been carried out, the mixture is shaped by extrusion or granulation. Finally, a drying step is carried out.

The extrusion or granulation operation is performed according to techniques that are well known to those skilled in the art, for example extrusion through a die, a grate, etc., or granulation using a granulator or a turbosphere, inter alia.

Concrete but nonlimiting examples of the invention will now be given.

### 1. EXAMPLE 1

50 kg of an aqueous solution of Geropon T36® with a solids content of 26.3% (sold by the company Rhodia Chimie) and 13.5 kg of Rhodasurf 860 P® (ethoxylated alcohol sold by the company Rhodia Chimie) are introduced into a tank.

A solution comprising 600 ml of deionized water and 250 g of sodium hydroxide is then added.

Next, the mixture is stirred at ambient temperature for one hour (80 rpm).

A solution with a solids content of 40% is thus obtained.

The viscosity of the solution is 1 100 mPa·s (Brookfield RVT 20, needle 4).

The solution is then dried in a Duprat® dryer (scraped rotary drum). Conditions: pvapor in the drum: 3 bar (about 135° C.); contact time of the solution with the drum: 29 seconds; powder flow rate: 5.6 kg/hour.

A powder with a water content of 2.5% by weight is obtained.

The physicochemical characteristics of the powder after redissolving it in water are measured using a Lauda hanging-drop tensiometer.

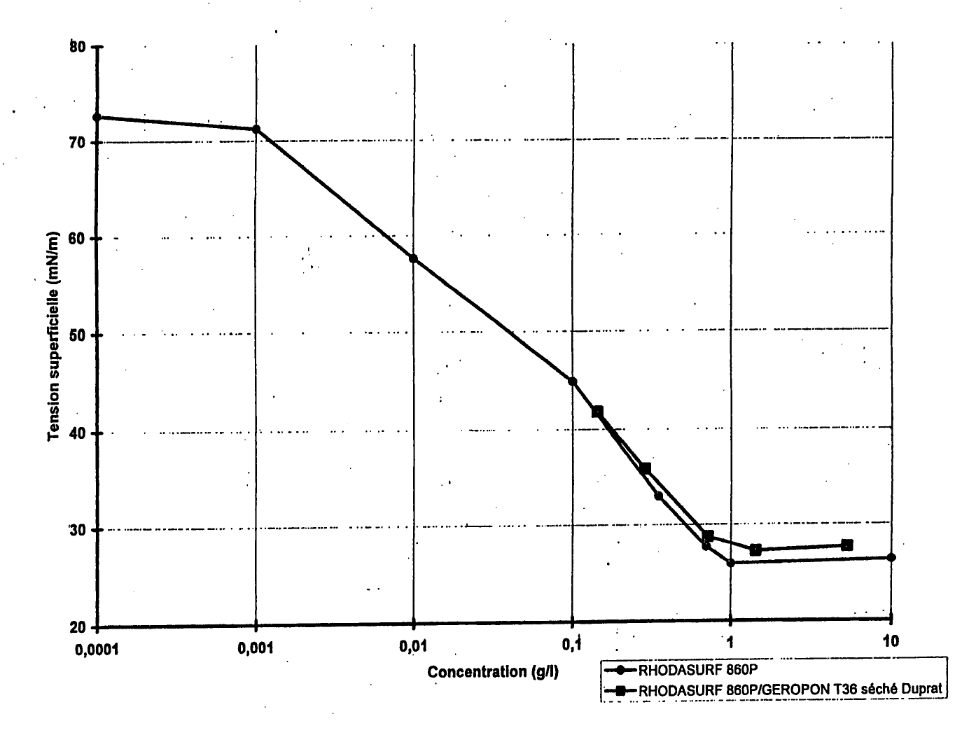

The curve given in FIG. 1 shows the surface tension of the composition according to the invention once redissolved, compared with that of a solution comprising only the surfactant.

The curve clearly shows that the surface tension properties are conserved.

### 2. EXAMPLE 2

1/ Preparation of the Dry Surfactant

63.4 g of Rhodafac ARB 70 (mixture of ethoxylated hydrogen alkyl phosphates—solution at 70% by weight in water—sold by Rhodia Chimie) and 37 g of ESA EP 796 (maleic acid/acrylic acid copolymer (Mw≈150 000 g/mol—solution at 46.2% by weight in water—sold by BASF) are mixed together. 15.1 g of sodium hydroxide (50% by weight) are then added with stirring and the resulting mixture is dried, in the form of a thin film, in an oven for 12 hours at 75° C.

A crystalline solid is obtained, which may be ground.

The solid obtained contains 68% Rhodafac ARB in dry form.

2/ Preparation of a Glyphosate-Based Formulation

53.5% of glyphosate (acid equivalent—100% of active material) are mixed with 21% of ammonium sulfate and 25.5% of the dry surfactant obtained in point 1.

11.5 ml of water are then added per 100 g of above mixture, and the resulting mixture is extruded.

The granules are then dried.

It should be noted that it is not possible to extrude a mixture comprising 44.4% of glyphosate (acid equivalent—100% of active material), 37.6% of ammonium sulfate and 17.8% of Rhodafac ARB 70 (solution at 70% in water).

1. A process of preparing a composition in a solid form, said composition consisting essentially of:
at least one low-melting surfactant, having a melting point lower than 80° C. selected from the group consisting of:
polyoxyalkylenated fatty alcohols,
polyoxyalkylenated triglycerides,
polyoxyalkylenated fatty acid esters,
polyoxyalkylenated sorbitan esters,
polyoxyalkylenated fatty acid amides,
polyoxyalkylenated fatty amines,
polyoxyalkylenated amido amines,
polyoxyalkylenated bis(1-phenylethyl)-phenols,
polyoxyalkylenated tris(1-phenylethyl)-phenols,
polyoxyalkylenated alkylphenols,
products resulting from the condensation of ethylene oxide or of propylene oxide with ethylenediamine,
alkoxylated terpenic hydrocarbons, and
alkylpolyglycosides which may be obtained by condensation of glucose with primary fatty alcohols containing a C₄-C₂₀ alkyl group and having an average number of glucose units of about 0.5 to 3 per mole of alkylpolyglycoside; and
at least one polymer selected from the group consisting of:
(i) polymers or copolymers obtained by polymerization
of at least one monomer (I) bearing one or more functions chosen from the group consisting of: carboxylic acid in acid or salified form, carboxylic acid precursor, sulfonic acid, in acid or salified form, and/or
of at least one polyoxyalkylenated ethylenically unsaturated carboxylic acid ester monomer (II), and optionally
of at least one monoethylenically or polyethylenically unsaturated, nonionic, linear or branched C₃-C₁₂ monomer (III);
(ii) polymers obtained by polymerization of at least one monomer (I) bearing one or more functions selected from the group consisting of carboxylic acid in acid or salified form, or carboxylic acid precursor, and sulfonic acid, in acid or salified form, the polymer also having at least one saturated or unsaturated, aromatic or nonaromatic C₄-C₃₀ hydrocarbon-based hydrophobic graft, optionally interrupted with one or more hetero atoms;
(iii) polymers obtained by polymerization of at least one monoethylenically or polyethylenically unsaturated linear or branched monomer (V) bearing one or more hydroxyl groups or hydroxyl group precursor, the polymer also having at least one saturated or unsaturated, aromatic or nonaromatic C₄-C₃₀ hydrocarbon-based hydrophobic graft, optionally interrupted with one or more hetero atoms;
(iv) polypeptides of natural or synthetic origin having at least one saturated or unsaturated, aromatic or nonaromatic C₄-C₃₀ hydrocarbon-based hydrophobic graft, optionally interrupted with one or more hetero atoms; and
(v) highly depolymerized polysaccharides having at least one saturated or unsaturated, aromatic or nonaromatic C₄-C₃₀ hydrocarbon-based hydrophobic graft, optionally interrupted with one or more hetero atoms, wherein the weight ratio of the concentrations between the low-melting surfactant and the polymer is between 50/50 and 90/10, said process comprising the following steps:
preparing an aqueous solution comprising said at least one low-melting surfactant and said at least one polymer,
drying the solution thus obtained.

2. The process as claimed in claim 1, wherein the polymer (i) is obtained by polymerization of at least one monomer of formula (I) (R¹)(R¹)C═C(R¹)—COOH; in which formula the radicals R¹, which may be identical or different, represent a hydrogen atom, a C₁-C₁₀ hydrocarbon-based radical optionally having a —COOH group, or a —COOH group; said monomer optionally being in the form of an anhydride if it contains several carboxylic functions.

3. The process as claimed in claim 1, wherein the polymer (i) is obtained by polymerization of at least one monomer of formula (II) CH₂═C(R²⁰)—C(O)—O—[CH(R²¹)CH(R²²)O]ₘ—[CH₂—CH₂O]ₙ—R²³ in which formula:
R²⁰ is a hydrogen atom or a methyl radical,
R²¹ and R²² represent a hydrogen atom or an alkyl radical containing from 1 to 4 carbon atoms, on condition that they are not both simultaneously an alkyl radical or a hydrogen atom;
*R²³ is an alkyl, aryl, alkylaryl or arylalkyl radical containing from 1 to 30,
*n is between 2 and 100 and m is between 0 and 50, with the proviso that n is greater than or equal to m and their sum is between 2 and 100; the position of the blocks —CH(R²¹)CH(R²²)O— and —CH₂—CH₂O— possibly being inverted.

4. The process as claimed in claim 1, wherein the polymer (i) is obtained by polymerization of at least one monomer of formula (III) (R³¹) (R³²)C═CH₂ in which formula:
*the radicals R³¹ and R³², which may be identical or different, represent a linear or branched C₁-C₁₀ hydrocarbon-based radical or a hydrogen atom, on condition that R³¹ and R³² do not simultaneously represent a hydrogen atom;
*furthermore:
if R³¹ is a hydrogen atom, then R³² represents a ″ group —COOR^{a}, —OCOR^{a}, —C₆H₄R^{b}, —CONHR^{a} or —CON(R^{a})₂,
if R³¹ is a methyl radical, then R³² represents a group —COORa, —C₆H₄Rb, —CONHRa or —CON(Ra)2, in which formulae R^{a}, which may be identical or different, represent a C₁-C₁₀ alkyl group or a C₁-C₁₀ hydroxyalkyl group, R^{b} represents a hydrogen, chlorine or bromine atom or a C₁-C₄ alkyl group.

5. The process as claimed in claim 1, wherein the polymer (i) is obtained by polymerization of at least one monomer of formula (I) and at least one monomer of formula (II), or of at least one monomer of formula (I) and at least one monomer of formula (III).

6. The process as claimed in claim 1, wherein the monomer (I) of the polymer (i) or (ii) is a monocarboxylic or polycarboxylic acid corresponding to the following formula:
(R¹¹)HC═C(R²)COOH in which formula:
*R¹¹ represents a hydrogen atom, a —COOH group or a group —(CH₂)ₙ—COOH in which n is between 1 and 4, or a C₁-C₄ alkyl radical;
*R¹² represents a hydrogen atom, a group —(CH₂)ₘ—COOH in which m is between 1 and 4, or a C₁-C₄ alkyl radical;
said acid optionally being in the form of an anhydride if it has several carboxylic functions.

7. The process as claimed in claim 6, wherein the monomer (I) of the polymer (i) or (ii) is such that the radical R¹¹ represents a hydrogen atom, a —COOH or —(CH₂)—COOH group, a methyl radical, and the radical R¹² represents a hydrogen atom, a —CH₂—COOH group or a methyl radical.

8. The process as claimed in claim 1, wherein the monomer (I) of the polymer (i) or (ii) is acrylic, methacrylic, citraconic, maleic, fumaric, itaconic and crotonic acid or anhydride.

9. The process as claimed in claim 1, wherein the monomer (II) is such that R²³ is an alkyl radical comprising from 8 to 30 carbon atoms, a phenyl radical substituted with one to three 1-phenylethyl groups, or an alkylphenyl radical in which the alkyl radical contains from 8 to 16 carbon atoms.

10. The process as claimed in claim 1, wherein the monomer (III) is selected from the group consisting of ethyl acrylate, ethyl methacrylate, 2-ethylhexyl acrylate, butyl acrylate, butyl methacrylate, 2-hydroxyethyl acrylate, 2-hydroxybutyl methacrylate, vinyl acetate, vinyl butyrate, vinyl caproate, styrene, vinyltoluene, tert-butylstyrene, hydroxystyrene, isopropylstyrene, p-chlorostyrene, N-substituted or N,N′-disubstituted (meth)acrylamides, propylene, 1-butene, isobutylene, n-1-pentene, 2-methyl-1-butene, n-1-hexene, 2-methyl-1-pentene, 4-methyl-1-pentene, 2-ethyl-1-butene, diisobutylene (or 2,4,4-trimethyl-1-pentene) and 2-methyl-3,3-dimethyl-1-pentene.

11. The process as claimed in claim 1, wherein the polymer (ii) also comprises one or more units corresponding to monomers of formula (III).

12. The process as claimed in claim 1, wherein the graft is selected from the group consisting of aliphatic, cyclic, aromatic, alkylaromatic and arylaliphatic radicals containing 4 to 30 carbon atoms and optionally being interrupted with one or more hetero atoms.

13. The process as claimed in claim 1, wherein the polymer (i) is derived from the polymerization of maleic anhydride and of 2,4,4-trimethyl-1-pentene.

14. The process as claimed in claim 1, wherein the polymer (iii) is derived from the polymerization of a monomer (V) corresponding to the following formula: (R⁵)(R⁵)C═CH₂ (V) in which formula the radicals R⁵, which may be identical or different, represent a linear or branched C₁-C₁₀ radical, at least one of them being a hydroxyl group or a precursor of a hydroxyl group.

15. The process as claimed in claim 1, wherein the polypeptides (iv) are selected from the group consisting of homopolymers and copolymers derived from at least aspartic acid or glutamic acid.

16. The process as claimed in claim 1, wherein the polysaccharides (v) are selected from the group consisting of highly depolymerized compounds obtained from dextran, from starch, from maltodextrin, from xanthan gum and from galactomannans.

17. The process of claim 1 wherein the low-melting surfactant is chosen from the group consisting of:
polyoxyalkylenated fatty alcohols
polyoxyalkylenated triglycerides
polyoxyalkylenated fatty acid esters
polyoxyalkylenated sorbitan esters
polyoxyalkylenated fatty acid amides
polyoxyalkylenated fatty amines
polyoxyalkylenated amido amines
polyoxyalkylenated bis(1-phenylethyl)phenols
polyoxyalkylenated tris(1-phenylethyl)phenols
polyoxyalkylenated alkylphenols
products resulting from the condensation of ethylene oxide or of propylene oxide with ethylenediamine
alkoxylated terpenic hydrocarbons such as polyoxyalkylenated α- or β-pinene derivatives
alkylpolyglycosides obtained by condensation of glucose with primary fatty alcohols containing a C₄-C₂₀ alkyl group and also an average number of glucose units of about 0.5 to 3 per mole of alkylpolyglycoside;
sulfated or phosphated polyoxyalkylenated fatty alcohols
sulfated or phosphated polyoxyalkylenated bis(1-phenylethyl)phenols
sulfated or phosphated polyoxyalkylenated tris(1-phenylethyl)phenols, and
sulfated or phosphated polyoxyalkylenated alkylphenols.

19. The process according to claim 1 wherein the low-melting surfactant is chosen from the group consisting of:
polyoxyalkylenated fatty alcohols
polyoxyalkylenated triglycerides
polyoxyalkylenated fatty acid esters
polyoxyalkylenated sorbitan esters
polyoxyalkylenated fatty acid amides
polyoxyalkylenated fatty amines
polyoxyalkylenated amido amines
polyoxyalkylenated bis(1-phenylethyl)phenols
polyoxyalkylenated tris(1-phenylethyl)phenols
polyoxyalkylenated alkylphenols
products resulting from the condensation of ethylene oxide or of propylene oxide with ethylenediamine
alkoxylated terpenic hydrocarbons and
alkylpolyglycosides obtained by condensation of glucose with primary fatty alcohols containing a C₄-C₂₀ alkyl group and also an average number of glucose units of about 0.5 to 3 per mole of alkylpolyglycoside.

20. The process as claimed in claim 1, wherein the low-melting surfactant has a melting point of less than 50° C.

21. The process as claimed in claim 1, wherein the aqueous solution comprises 10% to 99% by weight of solids.

22. The process as claimed in claim 1, wherein drying is conducted by spraying.

23. The process as claimed in claim 1, wherein drying is carried out using a dryer comprising a scraped rotary drum.

24. A process of preparing a plant-protection formulation comprising:
a) preparing a composition according to the method of claim 1, and
b) adding the composition to a plant protection active material, in an amount of between 10 to 40% by weight.
